(19) United States
(12) Patent Application Publication
(10) Pub. No.: US 2026/0153353 A1
(43) Pub. Date: Jun. 4, 2026

(54) PROCESSOR AND METHOD FOR SIMULTANEOUS LOCALIZATION AND MAPPING BASED ON REAL-TIME NEURAL NETWORK RENDERING USING SPARSE MIXTURE-OF-EXPERTS MODEL ACCELERATION ARCHITECTURE

(71) Applicant: Korea Advanced Institute of Science and Technology, Daejeon (KR)

(72) Inventors: Hoi Jun YOO, Daejeon (KR); Gwang Tae PARK, Daejeon (KR)

(73) Assignee: Korea Advanced Institute of Science and Technology, Daejeon (KR)

(21) Appl. No.: 19/253,970

(22) Filed: Jun. 30, 2025

(30) Foreign Application Priority Data
Dec. 3, 2024 (KR) 10-2024-0177864

(51) Int. Cl. G01C 21/00; G05B 13/02

(52) U.S. Cl. CPC G01C 21/3833; G01C 21/3874; G05B 13/027

(57) ABSTRACT

A processor includes a sampling unit configured to hierarchically sample a 2D image collected through any image collection device and pose information of the image collection device corresponding to the 2D image, and a rendering unit configured to perform SLAM through real-time rendering for data sampled by the sampling unit, wherein the rendering unit includes a computation core configured to perform a neural network operation based on a sparse expert model including a plurality of expert neural networks and reducing a number of neural network channels by exclusively activating an expert neural network differently selected for each input batch, and a scheduler configured to schedule a processing order of input batches to improve computational efficiency of the computation core.

### CROSS-REFERENCE TO RELATED APPLICATION

This application claims the benefit of Korean Patent Application Nos. 10-2024-0177864 filed on Dec. 3, 2024 in the Korean Intellectual Property Office, the entire disclosure of which is incorporated herein by reference for all purposes.

### BACKGROUND OF THE INVENTION

### Field of the Invention

The present invention relates to a processor and method for simultaneous localization and mapping (hereinafter referred to as SLAM), and more particularly to a processor and method for SLAM based on real-time neural network rendering using a sparse mixture-of-experts (SMoE) model acceleration architecture.

### Description of the Related Art

A visual SLAM algorithm is a computer vision algorithm essentially used for various devices such as robots and augmented reality (AR) glasses, which receives data of a camera attached to a specific device and generates three-dimensional (3D) map information of an exact location of the device and a surrounding environment. For example, the SLAM algorithm may allow a robot with a camera installed thereto to move and collect images of surroundings, and create a map of the surroundings using the images of the surroundings, while at the same time determining a relative location of the robot.

To this end, the SLAM algorithm includes a tracking step and a mapping step, which are repeatedly executed by forming a feedback loop with each other. First, in the tracking step, a current camera position is estimated by utilizing a new camera image and up-to-date 3D map information, and in the mapping step, a past camera position and a camera image at each position are received as input to update a 3D map.

In relation thereto, Korean Patent Publication No. 10-2022-0074782 discloses a SLAM method including a step of acquiring a current frame image input through a camera, a step of performing scene recognition on the current frame image to acquire a key frame image having the highest similarity to the current frame image in a global map, and a step of determining a camera pose of the current frame image based on the key frame image.

Meanwhile, the SLAM algorithm may be divided into an existing hand-crafted SLAM algorithm and a neural network rendering-based SLAM algorithm that uses a neural network rendering technology represented by Neural Radiance Fields (NeRF) depending on the method of expressing the 3D map. The former case has low data compression efficiency by utilizing 3D expression methods such as point cloud and voxel, which has the limitation of causing a memory bottleneck in mobile devices. On the other hand, the latter case has a characteristic of efficiently expressing high-density 3D scenes with small memory requirements by compressing and storing 3D information as parameters of a neural network.

In addition, a neural network-based representation method has an advantage of being more robust to sensor noise than traditional 3D representations and of being able to predict unobserved areas, and thus has an advantage of being able to achieve high performance in various 3D applications such as autonomous robotics.

However, while this NeRF-based SLAM has an advantage of being able to generate a dense 3D map, the NeRF-based SLAM requires more processing power than general two-dimensional (2D) image processing due to repetitive training of a neural network to compress and store wide 3D spatial information in parameters of the NeRF neural network, and thus has a problem of high delay time.

In addition, the NeRF-based SLAM requires high-performance server-side hardware such as a graphics processing unit (GPU) for real-time processing since a trained NeRF of the NeRF-based SLAM is immediately utilized in a tracking process.

Therefore, a lightweight NeRF-based SLAM is required for acceleration on mobile devices.

Meanwhile, mapping and tracking steps included in the SLAM algorithm are interdependent and therefore have a characteristic that parallelization is impossible. However, since a conventional SLAM processor accelerates these mapping and tracking steps on different hardware structures, most of the hardware resources are not used in each step, which problematically limits the ability to achieve high throughput.

### SUMMARY OF THE INVENTION

Therefore, in order to solve the above-mentioned problem, the present invention provides a processor and method for SLAM capable of solving a high latency problem of a neural network rendering algorithm by applying a real-time neural network (Sparse Mixture-of-Experts based Neural Radiance Fields, hereinafter referred to as “SMoE-NeRF”) rendering technology that utilizes an SMoE model acceleration architecture requiring a small amount of computation relative to parameters, thereby reducing the amount of computation, and consequently achieving acceleration in mobile devices.

In addition, the present invention provides a processor and method for SLAM that solve a problem of frequent memory access required in an SMoE algorithm by rearranging expert model access patterns that dynamically change according to input batches out of order, then converting the patterns into matrix multiplication operations and processing the operations, thereby achieving high throughput.

In addition, the present invention provides a processor and method for SLAM that apply an HCG SC (Heterogeneous Coarse Grained-Sparse Core) optimized for a data sparsity pattern, thereby further accelerating a SLAM algorithm while achieving high energy efficiency at the same time.

In addition, the present invention provides a processor and method for SLAM enabling low-power mapping by removing unnecessary 2D pixels in preprocessing of a neural network operation.

In accordance with an aspect of the present invention, the above and other objects can be accomplished by the provision of a processor for simultaneous localization and mapping (SLAM) based on real-time neural network rendering including a sampling unit configured to hierarchically sample a two-dimensional (2D) image collected through any image collection device and pose information of the image collection device corresponding to the 2D image, and a rendering unit configured to perform SLAM through real-time rendering for data sampled by the sampling unit, wherein the rendering unit includes a computation core configured to perform a neural network operation based on a sparse expert model including a plurality of expert neural networks and reducing a number of neural network channels by exclusively activating an expert neural network differently selected for each input batch, and a scheduler configured to schedule a processing order of input batches to improve computational efficiency of the computation core.

Preferably, the computation core may include n expert neural network operators having N/n channels to perform an operation on a neural network having N channels, and an expert decision neural network operator configured to dynamically select an expert neural network operator to be activated for each input batch among the n expert neural network operators, and the expert decision neural network operator includes n output channels corresponding to the n expert neural network operators, respectively, performs an expert decision operation for each input batch which is input in order, and then selects a plurality of expert neural network operators for processing respective corresponding input batches according to a result thereof to activate a plurality of expert neural network operators corresponding to a plurality of output channels having largest expert decision operation results, respectively, for each input batch, where N and n are natural numbers greater than or equal to 1.

Preferably, the scheduler may schedule a processing order of the input batches based on a selection result of the expert decision neural network operator, and perform scheduling so that input batches in which a plurality of expert neural network operators activated for each input batch does not overlap are selected out of order and processed in parallel.

Preferably, the scheduler may receive selection information obtained by expressing, as 1-bit data, information on a plurality of expert neural network operators activated for each input batch from the expert decision neural network operator to generate a decision map DMAP, generate a score, which is weight information, between the plurality of expert neural network operators activated for each input batch, and then schedule a processing order of the input batches out of order based on the decision map DMAP and the score.

Preferably, the rendering unit may further include an input/output memory in which M memory banks are arranged in order, where M is a natural number greater than or equal to 1, and the scheduler may be configured to generate M fist-in-first-out (FIFO) buffers arranged in order to correspond to the memory banks, respectively, then rearrange an access order of each of the input batches using the FIFO buffers, and schedule out-of-order access of the memory banks so that a predetermined number of rearranged input batches is simultaneously stored in corresponding memory banks using a FIFO method.

Preferably, the computation core may further include at least one integrated expert neural network operator for integrating and processing workload of each of a plurality of expert neural network operations, and the scheduler may couple a plurality of expert neural network operators so that total workload becomes similar based on workload of each of the expert neural network operators, and then perform scheduling so that combined workload of the plurality of coupled expert neural network operators is processed by a single integrated expert neural network operator.

Preferably, the computation core may include a single skip computation core configured to perform an operation for inference and backpropagation steps of the neural network operation and perform a matrix multiplication operation of a sparse matrix and a dense matrix, and a double skip computation core configured to perform an operation for a weight update step of the neural network operation and perform a matrix multiplication operation of a sparse matrix and a sparse matrix.

Preferably, the sampling unit may include a 2D sampling unit configured to sample the 2D image, and a three-dimensional (3D) sampling unit configured to sample 3D data which is pose information of the image collection device, and the 2D sampling unit and the 3D sampling unit may be configured as a pipeline structure so that 2D image sampling and 3D data sampling are processed in parallel.

Preferably, the 2D sampling unit may identify a positional relationship between 2D image samples in different time periods, and determine at least one familiar pixel predicted to have a low loss value among the 2D image samples in different time periods, and the scheduler may schedule a processing order of the input batches so that mapping to the familiar pixel is skipped.

In accordance with another aspect of the present invention, there is provided a method for SLAM based on real-time neural network rendering using a SLAM processor configured to perform SLAM based on real-time neural network rendering, the method including a sampling step of hierarchically sampling, by the SLAM processor, a 2D image collected through any image collection device and pose information of the image collection device corresponding to the 2D image, and a rendering step of performing, by the SLAM processor, SLAM through real-time rendering for data sampled in the sampling step, wherein the rendering step includes a scheduling step of scheduling a processing order of input batches to improve computational efficiency, and a computation step of performing a real-time neural network operation based on a sparse expert model including a plurality of expert neural networks and reducing a number of neural network channels by exclusively activating an expert neural network differently selected for each input batch, and performing a neural network operation on the input batches based on information scheduled in the scheduling step.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of a SLAM processor based on real-time neural network rendering according to an embodiment of the present invention;

FIG. 2 is a diagram illustrating a processing process of a 2D sampling unit according to an embodiment of the present invention;

FIG. 3 is a diagram illustrating a structure of a neural network to which an SMoE model is applied for real-time rendering according to an embodiment of the present invention;

FIG. 4 is a diagram illustrating an example in which input batches are scheduled out of order according to an embodiment of the present invention;

FIG. 5 is a diagram for describing an out-of-order operation process based on the SMoE model according to an embodiment of the present invention;

FIG. 6 is a diagram for describing a out-of-order access process for preventing a memory bank conflict according to an embodiment of the present invention;

FIG. 7 is a diagram for describing an integrated processing process for improving computational efficiency of an expert operator according to an embodiment of the present invention;

FIG. 8 is a diagram for describing a structure of a computation product accelerator of a computation core according to an embodiment of the present invention; and

FIGS. 9 to 14 are schematic processing flow diagrams for a SLAM method based on real-time neural network rendering according to an embodiment of the present invention.

### DETAILED DESCRIPTION OF THE INVENTION

Hereinafter, embodiments of the present invention will be described with reference to the attached drawings, and will be described in detail so that those skilled in the art may easily practice the present invention. However, the present invention may be implemented in various different forms and is not limited to the embodiments described herein. Meanwhile, in order to clearly describe the present invention in the drawings, parts that are not related to the description are omitted, and similar parts are designated with similar drawing reference numerals throughout the specification. In addition, descriptions of parts that may be easily understood by those skilled in the art even when a detailed description is omitted are omitted.

Throughout the specification and claims, when a part is described as including a certain component, this does not exclude other components, but rather implies that the part may include other components, unless specifically stated otherwise.

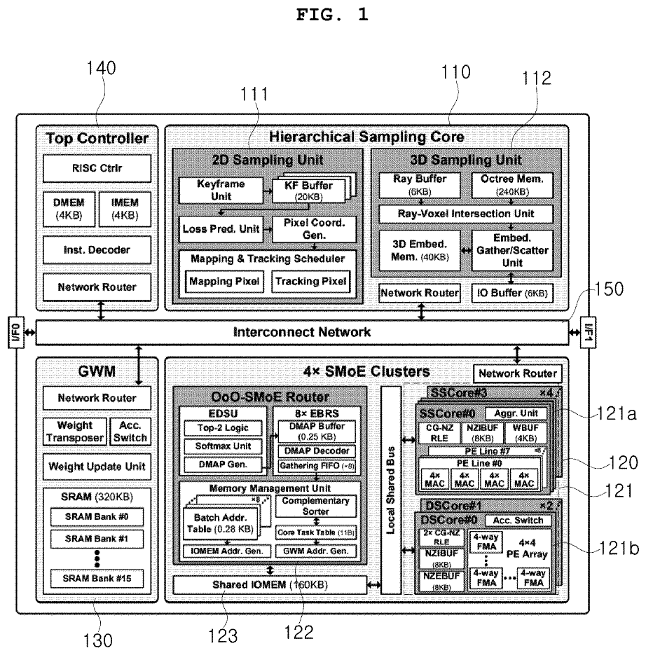

FIG. 1 is a schematic block diagram of a SLAM processor based on real-time neural network rendering according to an embodiment of the present invention, and illustrates a configuration example of a simultaneous localization and mapping processor (hereinafter referred to as “SLAM processor”) to which a real-time neural network rendering technology utilizing a sparse mixture-of-experts (SMoE) model acceleration architecture (SMoE-NeRF) is applied.

Referring to FIG. 1, a SLAM processor 100 according to an embodiment of the present invention is a device that accelerates preprocessing of an SMoE-NeRF operation proposed in the present invention, and includes a sampling unit 110, a rendering unit 120, a memory unit (global weight memory (GWM)) 130, and a controller (Top Controller) (140), each of which may exchange data via an internal network (Interconnect Network) 150.

The memory unit (GWM) 130 stores parameters for performing a neural network operation of the present invention, and the controller (Top Controller) 140 controls the overall operation of the SLAM processor 100.

The sampling unit (aka Hierarchical Sampling Core (HSC)) 110 operates as a preprocessor that performs 2D and 3D sampling, and hierarchically samples 2D images collected by any image collection device (e.g., a camera, etc.) and pose information (i.e., 3D data) of the image collection device corresponding to the 2D images. Here, hierarchical sampling refers to a process of sampling points at a constant interval in each bin, randomly generating points within the bin, and performing more sampling at points with high density in a fine sampling process after a coarse sampling step, thereby performing additional training as a method of optimizing NeRF.

To this end, the sampling unit HSC 110 may include a 2D sampling unit 111 that samples the 2D images (also referred to as “pixels”), and a 3D sampling unit 112 that samples 3D data (e.g., 6DoF data), which is position information of the image collection device.

In addition, the sampling unit HSC 110 configures the 2D sampling unit 111 and the 3D sampling unit 112 as a pipeline structure to process the 2D image sampling and 3D data sampling processes in parallel. As a result, the present invention has a feature of reducing a computation time for sampling.

In addition, in the 2D image sampling process, the 2D sampling unit 111 performs a process of identifying whether or not a previously performed mapping result may be used for each pixel of a new image each time the new image is imported. This process is performed to omit mapping of identified pixels (or pixel areas) during a subsequent mapping process.

As a result, the present invention has a feature of enabling low-power mapping and, as a result, reducing power consumption of the SLAM processor 100.

To this end, the 2D sampling unit 111 may determine and identify one or more familiar pixels among the 2D image samples in different time periods by identifying a positional relationship between the 2D image samples in the different time periods. In this instance, the familiar pixel refers to a pixel whose loss value predicted using a pixel-by-pixel loss value of a pre-generated key frame is less than or equal to a preset specific threshold value TH_{LOSS}.

A system scheduler, which will be described later, may receive information on the familiar pixel, and schedule a processing order of input batches so as to omit mapping to the familiar pixel based on the information.

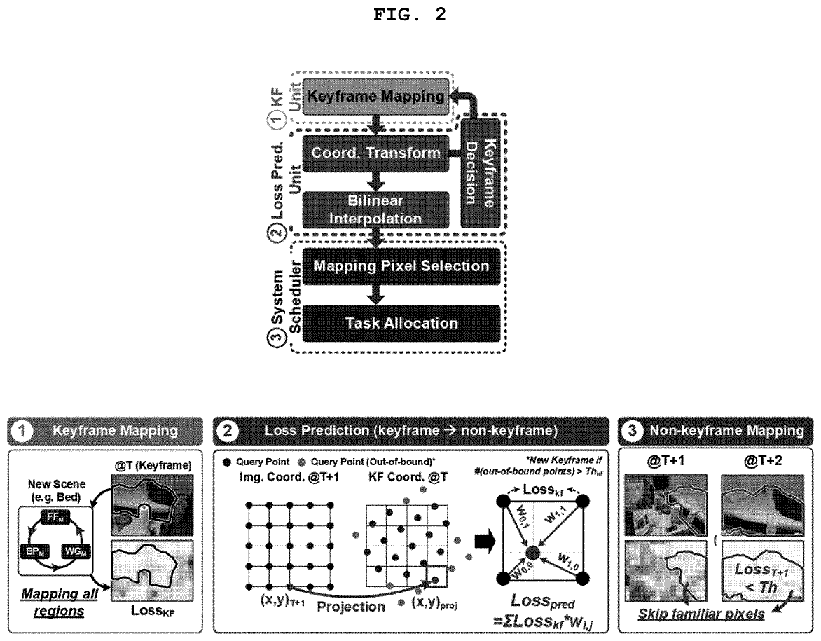

FIG. 2 illustrates a process in which the 2D sampling unit 111 determines the familiar pixel.

FIG. 2 is a diagram schematically illustrating a processing process of the 2D sampling unit according to an embodiment of the present invention. Referring to FIG. 2, the 2D sampling unit 111 may include a keyframe unit (KF Unit), a loss prediction unit (Loss Pred. Unit), and a system scheduler.

The keyframe unit performs a mapping process on all pixels whenever a keyframe KF is generated, and stores a keyframe loss value generated as a result thereof.

The loss prediction unit predicts a loss value (loss) for each pixel whenever a new image is imported. To this end, the loss prediction unit utilizes the keyframe loss value. Specifically, the loss prediction unit projects pixels of a current frame onto a keyframe KF through 3D coordinate transformation, and performs bilinear interpolation to predict an expected loss value for a corresponding pixel.

The system scheduler stores a preset specific threshold value TH_{LOSS} and compares a loss value predicted by the loss prediction unit with the specific threshold value TH_{LOSS} to determine whether to perform mapping to each pixel. That is, when the predicted loss value is less than or equal to the specific threshold value TH_{LOSS}, the system scheduler assumes that mapping to the corresponding 2D image pixel has been sufficiently performed in a previous frame, so that a subsequent mapping process may be omitted.

In this way, the 2D sampling unit 111 projects loss value information of the previous key frame pixel onto the current frame, thereby identifying a pixel predicted to have a small loss value as familiar pixel (or familiar pixel area), and enables mapping to the corresponding area to be omitted in the subsequent mapping process.

The rendering unit 120 performs simultaneous localization (tracking) and map creation (mapping) through real-time rendering of data sampled from the sampling unit 110. To this end, the rendering unit 120 includes a computation core 121 that performs neural network operations, a scheduler 122 that schedules a processing order of input batches, and an input/output memory 123.

The computation core 121 performs real-time neural network rendering on input batches according to information scheduled by the scheduler 122, and may include a plurality of computation core clusters in order to process a plurality of batches in parallel. In the example of FIG. 1, the computation core 121 includes four computation core clusters in order to process four batches in parallel at one time.

In particular, the computation core 121 performs real-time neural network rendering based on the SMoE model. In this instance, the SMoE model is characterized by reducing the number of neural network channels by activating only expert neural networks differently selected for each input batch while having a plurality of expert neural networks.

To this end, to perform an operation for neural networks having N channels, the computation core 121 may include n expert neural network operators having N/n channels (where N and n are natural numbers greater than or equal to 1, the same applies hereinafter), and an expert decision neural network operator configured to dynamically select an expert neural network operator to be activated for each input batch among the n expert neural network operators.

In this instance, the expert decision neural network operator includes n output channels corresponding to the n expert neural network operators, respectively, performs an expert decision operation for each of the input batches which are input in order, and then selects a plurality of expert neural network operators for processing respective corresponding input batches according to a result thereof. Here, selection may be performed to activate a plurality of expert neural network operators corresponding to a plurality of output channels having largest expert decision operation results, respectively, for each input batch. A reason therefor is to rapidly improve accuracy by selecting a plurality of expert neural network operators having large losses among the expert neural network operators and continuing training.

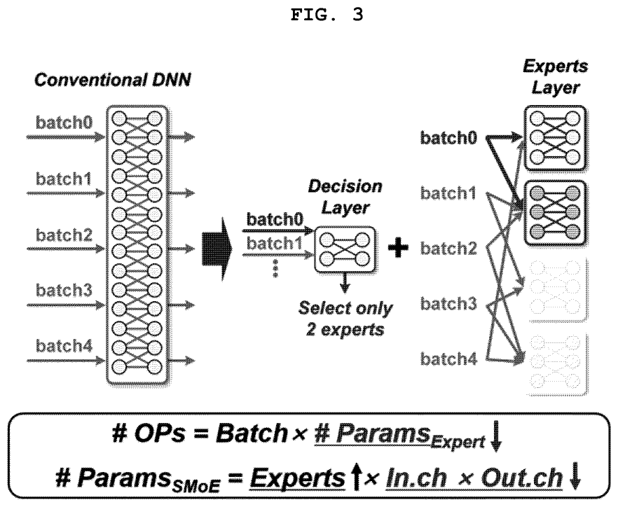

An example of a configuration of an SMoE model for real-time rendering of these computation cores 121 is illustrated in FIG. 3.

FIG. 3 is a diagram illustrating a structure of a neural network to which an SMoE model is applied for real-time rendering according to an embodiment of the present invention, and schematically compares a neural network to which the SMoE model is applied and a conventional neural network to which the SMoE model is not applied.

Referring to FIG. 3, while the conventional neural network (conventional DNN) includes a single layer, the neural network (SMoE-NeRF) to which the SMoE model is applied includes an expert decision neural network layer (hereinafter abbreviated as a decision layer) and an expert neural network layer (hereinafter abbreviated as an expert layer). In this instance, the decision layer selects only two experts for each batch, and the expert layer activates only two selected expert neural networks to perform an operation.

Therefore, each expert neural network has a reduced number of input/output channels compared to the conventional neural network, and as a result, the operation quantity of SMoE-NeRF is reduced. A reason therefor is that the operation quantity of SMoE-NeRF is proportional to a parameter size of the expert neural network. For example, when each expert neural network has N/4 input/output channels compared to the conventional neural network having N input/output channels, the operation quantity may be reduced by a factor of 6.9.

Meanwhile, the reduced parameter size is compensated by increasing the number of experts by the square of N since training accuracy is proportional to the parameter size.

That is, the present invention reduces the operation quantity by dividing a neural network into a plurality of neural networks to reduce the parameter size, and compensates for the decrease in accuracy by increasing the number of expert neural networks to preserve the entire parameter size. As a result, the present invention has a characteristic of achieving the same rendering quality as before in a short period of time by reducing the operation quantity while preserving accuracy.

Therefore, the computation core 121 may reduce the number of operations by being based on the SMoE model as illustrated in FIG. 3, thereby solving a problem of NeRF having a large number of operations.

The scheduler 122 schedules a processing order of input batches to improve computational efficiency of the computation core 121 and then transfers a result thereof to the computation core 121.

In particular, the scheduler 122 schedules the processing order of the input batches based on the selection result of the expert decision neural network operator, and may perform scheduling so that input batches in which a plurality of expert neural network operators activated for each input batch does not overlap are selected out of order and processed in parallel. For example, when a first expert neural network operator is activated in input batches 0 and 4, and a second expert neural network operator is activated in input batches 1 and 2 as a result of selection of the expert decision neural network operator, the first and second expert neural network operators are not activated in the same input batch, and thus parallel processing is possible. Accordingly, the scheduler 122 may selecting input batches 0 and 5 and input batches 1 and 2 out of order based on the above-mentioned information to schedule the first and second expert neural network operators to be processed in parallel. As a result, the present invention has an advantage in that processing efficiency may be improved by processing expert neural network operations in parallel.

To this end, the scheduler 122 may receive selection information obtained by expressing, as 1-bit data, information on a plurality of expert neural network operators activated for each input batch from the expert decision neural network operator to generate a decision map DMAP, generate a score, which is weight information, between the plurality of expert neural network operators activated for each input batch, and then schedule a processing order of the input batches out of order based on the decision map DMAP and the score. In this instance, the scheduler 122 may schedule the processing order of the input batches out of order so that each core processes the input batches in an order in which data stored in a specific column of the decision map DMAP is 1.

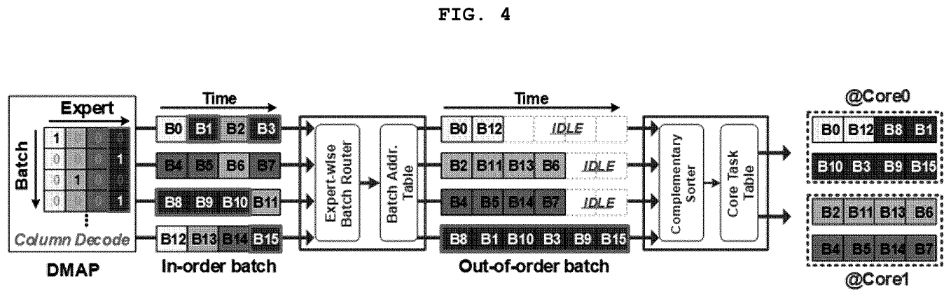

The processing process of the scheduler 122 is schematically illustrated in FIG. 4. FIG. 4 is a diagram illustrating an example in which input batches are scheduled out of order according to an embodiment of the present invention. Referring to FIG. 4, it can be seen that, among 16 input batches B0 to B15 input in order, 6 input batches B6, B1, B10, B3, B9, and B15 are scheduled out of order based on column (vertical) direction data of the DAMP.

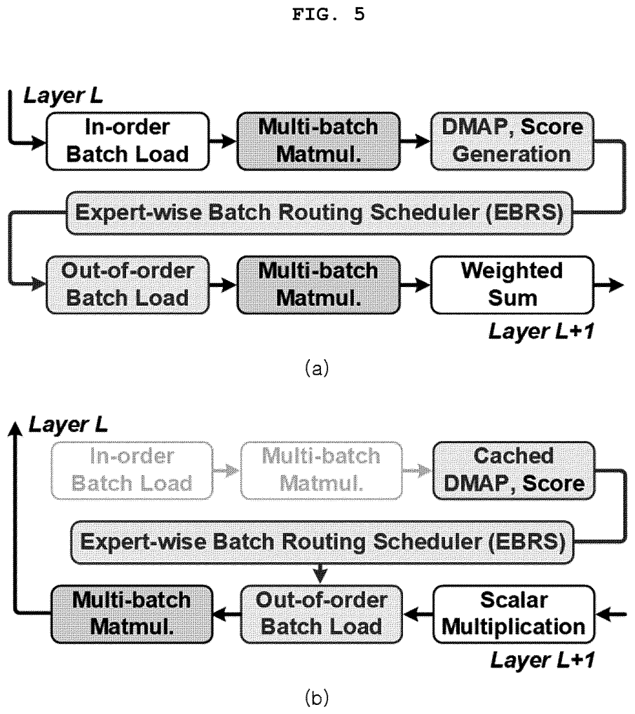

A processing process of the scheduler 122 and an out-of-order operation process resulting therefrom are illustrated in FIG. 5.

FIG. 5 is a diagram for describing an out-of-order operation process based on the SMoE model according to an embodiment of the present invention. FIG. 5A illustrates an out-of-order operation process in an inference FF process, and FIG. 5B illustrates an out-of-order operation process in a backpropagation BP process.

First, referring to FIG. 5A, in order to perform the inference FF process, the computation core 121 of the present invention first fetches batches in order to perform a decision layer operation, and generates a decision map DMAP and a score as results. In this instance, the decision map DMAP is memory information that records values expressing whether an expert is activated for each batch as 1-bit data, and the score expresses weight values for two activated experts.

Then, the scheduler (e.g., Expert-wise Batch Routing Scheduler, EBRS) 122 analyzes the decision map DAMP to determine an execution order of the batch out of order, and the computation core 121 performs out-of-order processing on the input batch based on the information. In this way, in the case of the inference FF process, the computation core 121 performs computation on the decision layer and the expert layer in order and out of order, respectively, according to a scheduling result of the scheduler 122.

Meanwhile, referring to FIG. 5B, in order to perform the backpropagation BP process, the computation core 121 of the present invention utilizes the previously generated and stored decision map DMAP and score without performing an operation of the decision layer. In other words, during the backpropagation BP process, the scheduler EBRS 122 schedules the backpropagation BP process of the expert layer so that the backpropagation BP process is processed out of order as in the reference FF process, and the computation core 121 performs an out-of-order operation of the expert layer based on a result thereof.

A reason why the scheduler 122 schedules the processing order of the input batches out of order is that, even though a typical neural network may be accelerated through a matrix multiplication (Matmul) operator since parallelization of several input batches is possible, in the case of an expert layer, since different experts are activated for each batch, when the input batches are processed in order, the existing operator exhibits low throughput performance, and thus the low throughput performance needs to be compensated. That is, the present invention enables each expert operation to be parallelized by scheduling the input batches to be processed out of order, thereby compensating for the low throughput as described above.

Meanwhile, when performing non-sequential processing of input batches as described above in SMoE-NeRF, random memory access patterns may occur, resulting in memory bank collision problems, which may result in additional delay time.

Meanwhile, when performing out-of-order processing of input batches as described above in SMoE-NeRF, random memory access patterns may occur, resulting in a problem of memory bank conflict, which may result in an additional delay time.

To this end, in addition, the scheduler 122 may generate fist-in-first-out (FIFO) buffers arranged in order to correspond to M (where M is a natural number greater than or equal to 1, the same applies hereinafter) memory banks included in the input/output memory 123, respectively, then rearrange an access order of each of the input batches using the FIFO buffers, and schedule out-of-order access of the memory banks so that a predetermined number of rearranged input batches is simultaneously stored in the corresponding memory banks using a FIFO method.

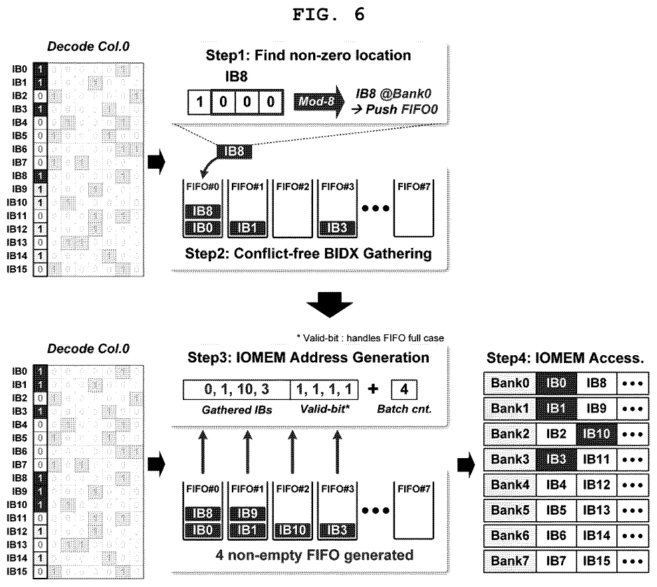

The processing process of the scheduler 122 and the out-of-order access process of the memory bank resulting therefrom are illustrated in FIG. 6.

FIG. 6 is a diagram for describing a out-of-order access process for preventing a memory bank conflict according to an embodiment of the present invention. Hereinafter, a description will be given of a processing process of the scheduler 122 (that is, the EBRS present in a OoO-SMoE (Out of-Order Sparse Mixture of Experts) Router) for supporting an out-of-order operation of the input batches by accessing input/output data out of order without a memory bank conflict from the expert layer with reference to FIG. 6.

First, when a total of M memory backs is present in the input/output memory 123, and a BIDX(batch index)th batch is determined by modulo-N(BIDX), the scheduler 122 first searches for a nonzero BIDX while performing decoding in a column direction of the decision map DMAP (Step 1). Then, a BIDX (that is, a nonzero BIDX) found in Step 1 is stored in a modulo-N(BIDX)th FIFO buffer (Step 2). Then, by repeating the above processes (Step 1 and Step 2), data is accumulated and stored in the FIFO (Step 3). As a result, the scheduler 122 may rearrange the access order of each input batch. That is, since the BIDX accessing the same memory bank is accumulated in the same FIFO by the above processes (Step 1 to Step 3), a bank conflict may be prevented. In addition, when k (where k is a value set so that the SLAM processor 100 may perform parallel processing) different FIFOs have BIDXs thereafter, that is, when one or more BIDXs are stored in all FIFOs, the scheduler 122 schedules memory access so that BIDXs stored in several FIFOs are output at once to generate a memory access request (Step 4).

The scheduler 122 may prevent memory bank conflicts by scheduling out-of-order access to memory banks as illustrated in FIG. 6.

In addition, to prevent efficiency degradation due to imbalance in workload of each of the expert neural network operators, the scheduler 122 may schedule processing of the computation core 121 based on the workload.

That is, the scheduler 122 may couple a plurality of expert neural network operators so that the total workload becomes similar based on the workload of each of the expert neural network operators, and then perform scheduling so that the integrated workload of the plurality of coupled expert neural network operators is processed by a single expert neural network operator. To this end, the computation core 121 may further include at least one integrated expert neural network operator for integrating and processing the plurality of coupled expert neural network operations.

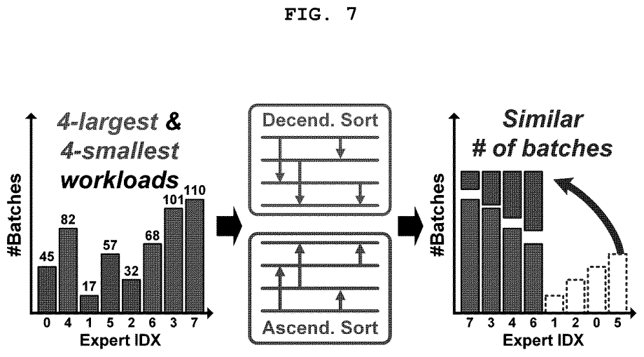

FIG. 7 is a diagram for describing an integrated processing process for improving computational efficiency of an expert operator according to an embodiment of the present invention. Referring to FIG. 7, the scheduler 122 may schedule a computation process so that complementary sorting-based task allocation is possible to solve a problem of workload imbalance between experts and maximize hardware utilization.

For example, as illustrated in FIG. 7, when eight expert operators exhibit balanced workload characteristics, the scheduler 122 divides each of the eight expert operators into two groups according to the size of the workload, and then mixes results by complementary sorting thereof. That is, the scheduler 122 divides expert operators 4, 6, 3, and 7 having relatively large workloads and expert operators 0, 1, 5, and 2 having relatively small workloads into large and small groups, respectively, then sorts the expert operators 4, 6, 3, and 7 of the large group in descending order according to workload, sorts the expert operators 0, 1, 5, and 2 of the small group in ascending order according to workload, and then mixes sorting results of each group as illustrated in FIG. 7. In addition, four mixed expert pairs having a similar number of batches are generated as a result, and the scheduler 122 may achieve high hardware utilization by performing scheduling so that each of the integrated neural network operators implemented in the computation core 121 performs processing thereof.

Meanwhile, the computation core 121 may be configured to have an arithmetic multiplication accelerator structure for effectively utilizing sparsity occurring in each step among inference FF, backpropagation BP, and weight update WG by reflecting characteristics of SMoE NeRF exhibiting different sparsity features in three training processes by being configured to have a structure in which an SMoE layer and a ReLU layer are alternately repeated.

To this end, as illustrated in FIG. 1, the computation core 121 may include four single skip computation cores (Single Skip Core, SSCore) 121a and two double skip computation cores (Double Skip Core, DSCore) 121b, each of the single skip computation cores SSCore 121a may be configured to perform a single skip operation for the inference FF and backpropagation BP steps of the neural network operation by a matrix multiplication operation of a sparse matrix and a dense matrix, and each of the double skip computation cores DSCore 121b may be configured to perform a double skip operation for a weight update step of the neural network operation by a matrix multiplication operation of a sparse matrix and a sparse matrix.

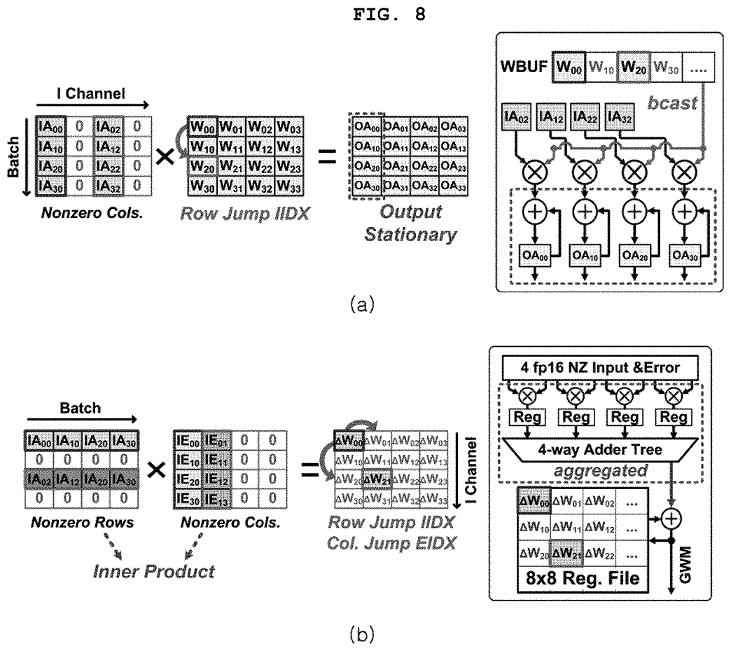

A configuration example of the computation core 121 is illustrated in FIG. 8.

FIG. 8 is a diagram for describing a structure of a computation product accelerator of the computation core according to an embodiment of the present invention. FIG. 8A illustrates an accelerator structure for the single skip computation core SSCore 121a, and FIG. 8B illustrates an accelerator structure for the double skip computation core DSCore 121b.

A description will be given of an operation of the single skip computation core SSCore 121a for accelerating the inference FF and backpropagation BP steps with reference to FIG. 8A.

First, in the inference FF step, an input activation IA value of the SMoE layer includes “0”, and a weight W value multiplied by this value does not include “0”. Meanwhile, in the backpropagation BP step, an input error IE value includes “0”, and a weight transpose WT value multiplied by this value does not include “0”. Therefore, both the inference FF and backpropagation BP steps have the common feature of being able to perform a matrix multiplication operation of a sparse matrix and a dense matrix.

Therefore, the single skip computation core SSCore 121a first performs zRLE (zero run-length encoding) on the original IA, and when a nonzero IA row and an input index IIDX corresponding thereto are generated as a result, an internal operator thereof determines an address of a weight buffer WBUF by utilizing the IIDX value, thereby performing a matrix multiplication operation of a sparse matrix and a dense matrix.

A description will be given of an operation of the double skip computation core DSCore 121b for accelerating the weight update WG step with reference to FIG. 8B.

First, in the weight update WG step, a gradient value of a weight W is generated by multiplying a transpose matrix value of input activation IA and an input error IE value, and thus there is a characteristic that a matrix multiplication operation of a sparse matrix and a dense matrix is performed.

Accordingly, the double skip computation core DSCore 121b performs zRLE on each of the original IA and IE, and when nonzero columns of the transpose matrix of the IA, input indices IIDX corresponding thereto, nonzero rows of the IE, and error indices EIDX corresponding thereto are generated as a result, the internal operator performs a matrix multiplication operation of a sparse matrix and a sparse matrix by determining an address of a partial sum register file using both the IIDX and EIDX values.

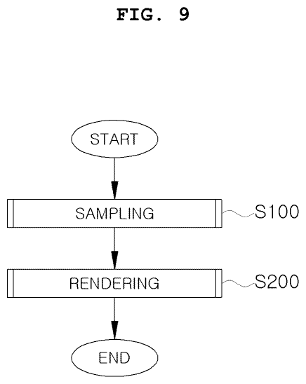

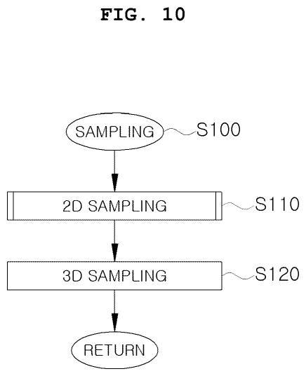

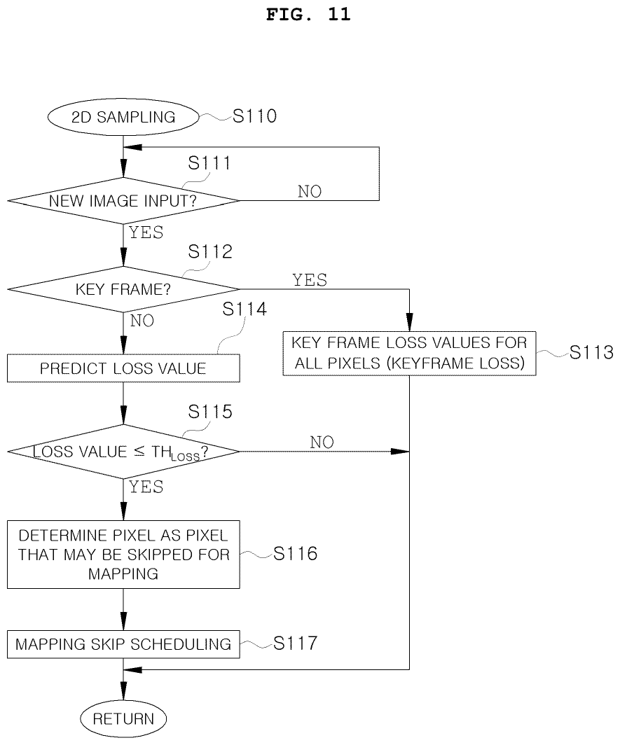

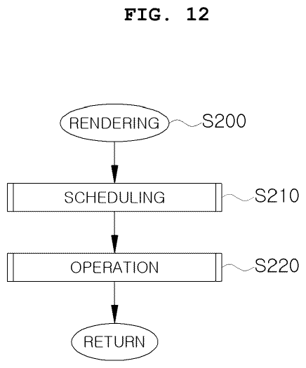

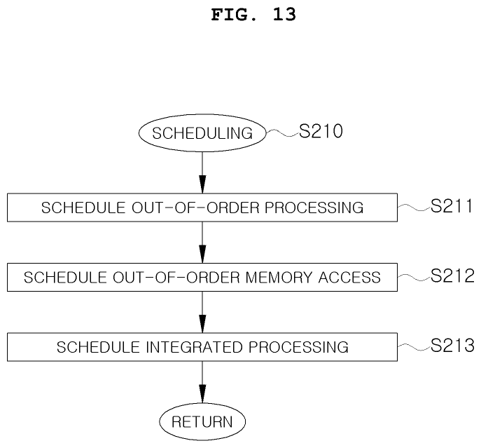

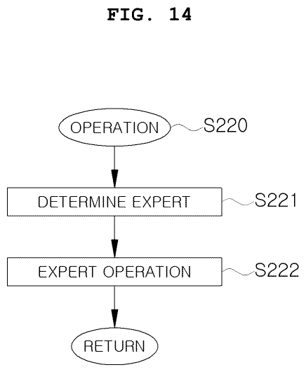

FIGS. 9 to 14 are schematic processing flow diagrams for a SLAM method based on real-time neural network rendering according to an embodiment of the present invention. Hereinafter, a description will be given of the SLAM method of the present invention with reference to FIG. 14.

First, in step S100, the sampling unit 110 hierarchically samples a 2D image collected through an arbitrary image collection device and position information of the image collection device corresponding to the 2D image. To this end, in step S110, the 2D sampling unit 111 samples the 2D image, and in step S120, the 3D sampling unit 112 samples 3D data, which is position information of the image collection device.

In this instance, steps S110 and S120 may be processed in parallel. A reason therefor is to reduce the overall computation time for real-time rendering by reducing the computation time for sampling.

Meanwhile, in the step S110, the 2D sampling unit 111 may perform a process of identifying a pixel predicted to have a low loss value from the image each time a new image is input, in order to omit mapping to a pixel previously mapped in a previous image during a mapping process performed thereafter (i.e., rendering for mapping (S200)). To this end, in step S111 to step S113, after determining whether a new image is a keyframe each time the new image is input, when the new image is a keyframe, the 2D sampling unit 111 generates keyframe loss values for all pixels and then stores the keyframe loss values.

Then, in step S114 to step S117, the 2D sampling unit 111 predicts a loss value per pixel for an image other than a key frame, and when the loss value is less than or equal to a preset specific threshold value TH_{LOSS}, the 2D sampling unit 111 determines the corresponding pixel as a pixel that may be skipped for mapping (so-called familiar pixel), and then performs a series of processes to perform scheduling so that mapping to the familiar pixel is skipped.

As a result, in a subsequent rendering step (step S200), mapping to the familiar pixel area may be skipped, and consequently, power consumption of the SLAM processor may be reduced.

In step S200, the rendering unit 120 performs SLAM through neural network operation on data sampled by the sampling unit 110.

To this end, in step S210, the rendering unit 120 schedules a processing order of input batches to improve computational efficiency.

In particular, in step S211, the scheduler 122 of the rendering unit 120 schedules the processing order of the input batches so that the input batches are processed out of sequence based on a selection result of an expert selection step (step S221) to be described later. That is, in step S211, the scheduler 122 may perform scheduling so that the plurality of expert neural network operators activated for each input batch selects non-overlapping input batches out of order and processes the non-overlapping input batches in parallel. To this end, in step S211, the scheduler 122 may receive selection information obtained by expressing, as 1-bit data, information on a plurality of expert neural network operators activated for each input batch from the expert decision neural network operator to generate a decision map DMAP, generate a score, which is weight information, between the plurality of expert neural network operators activated for each input batch, and then schedule the processing order of the input batches based on the decision map DMAP and the score.

In step S212, the scheduler 122 schedules out-of-order memory access. That is, in step S212, the scheduler 122 may generate M FIFO buffers arranged in order to correspond to M memory banks included in the SLAM processor, respectively, to store input/output batches, then rearrange an access order of each of the input batches using the FIFO buffers, and then schedule out-of-order access of the memory banks so that a predetermined number of rearranged input batches is simultaneously stored in the corresponding memory banks using the FIFO method.

In step S213, the scheduler 122 schedules integrated processing. That is, in step S213, the scheduler 122 may couple a plurality of expert neural network operators so that the total workload becomes similar based on the workload of each of the expert neural network operators, and perform scheduling to process the integrated workload of the plurality of coupled expert neural network operators using at least one integrated operator implemented to integrate and process the workload of each of any two expert neural network operators.

In step S220, the rendering unit 120 performs a neural network operation on the input batches based on the information scheduled in step S210. That is, in step S220, the rendering unit 120 may perform a real-time neural network operation based on an SMoE model that reduces the number of neural network channels by activating only an expert neural network differently selected for each input batch by including a plurality of expert neural networks.

That is, in step S221, the computation core 121 of the rendering unit 120 dynamically selects an expert neural network operator to be activated for each input batch among n expert neural network operators having N/n channels in order to perform an operation for a neural network having N channels, and in step S222, the computation core 121 performs an operation for the corresponding input batch using the expert neural network operator activated for each input batch in step S221.

In this instance, in step S221, the computation core 121 may perform an expert decision operation for each input batch input in order using an expert decision operator including n output channels corresponding to the n expert neural network operators, respectively, and then select a plurality of expert neural network operators for processing respective corresponding input batches according to an operation result of the expert decision operator. In particular, in step S221, the computation core 121 may perform selection to activate a plurality of expert neural network operators corresponding to a plurality of output channels having the largest expert decision operation results, respectively, for each input batch.

In addition, the step S220 may further include a single skip operation step (not shown) and a double skip operation step (not shown) of the computation core 121. A reason therefor is to efficiently utilize sparsity occurring in each step of inference FF, backpropagation BP, and weight update WG, reflecting the characteristics of SMoE-NeRF, which is configured with a structure in which SMoE layers and ReLU layers are alternately repeated and exhibits different sparsity characteristics in three training processes. In the single skip operation step (not shown), the computation core 121 may perform a matrix multiplication operation of a sparse matrix and a dense matrix for the inference and backpropagation steps, and in the double skip operation step (not shown), the computation core 121 may perform a matrix multiplication operation of a sparse matrix and a sparse matrix for the weight update step.

In the description of the method of the present invention with reference to FIGS. 1 to 14, redundant description of content mentioned in the description of the processor of the present invention with reference to FIGS. 1 to 8 has been omitted.

In addition, in the description with reference to FIGS. 1 to 14, the expert neural network operator, the expert decision neural network operator, and the integrated expert neural network operator represent virtual operators that perform a computational process for each neural network layer, and a type of operator may be determined depending on the operation mode of the computation core.

As described above, the processor and method for SLAM of the present invention may solve a problem of high latency of the neural network rendering algorithm by reducing the operation quantity by applying the real-time neural network (SMoE-NeRF) rendering technology utilizing the SMoE model acceleration architecture that requires a small operation quantity compared to the parameters, and as a result, may achieve acceleration in mobile devices. That is, the present invention has an effect of being able to reduce the operation quantity by a factor of 6.9 without accuracy loss compared to the existing SLAM algorithm by applying SMoE-NeRF.

In addition, the present invention solves a problem of frequent memory access required in the SMoE algorithm by rearranging an expert model access pattern that dynamically changes according to the input batch out of order, then converting the pattern into a matrix multiplication operation, and processing the operation, thereby having an effect of being able to achieve high throughput. That is, the present invention has an effect of achieving 6.5 times faster throughput by reducing the amount of data movement inside the chip by 88.8% compared to the existing hardware structure that processes the input batch in order by applying a scheduler (aka, OoO-SMoE router) that performs scheduling to process the input batch in order.

In addition, the present invention has an effect of additionally accelerating the SLAM algorithm while simultaneously achieving high energy efficiency by applying the HCG SC optimized for the data sparsity pattern. That is, the present invention may accelerate the matrix multiplication operation by utilizing sparsity in the HCG-SC core optimized for the data sparsity pattern occurring in three processes of neural network training, namely, inference FF, backpropagation BP, and weight update WG, thereby improving energy efficiency from 32.4% to 55.6% compared to the existing architecture and having an effect of additionally increasing throughput by 2.65 times.

In addition, the present invention has an effect of enabling low-power mapping by removing unnecessary 2D pixels in preprocessing of a neural network operation. That is, the present invention has an effect of being able to reduce energy consumption per frame by 42.9% compared to the conventional one while occupying only 2.8% of the area of the entire chip by identifying familiar pixels when a new image is input in the 2D sampling process, which is preprocessing of the neural network operation, and skipping mapping to the familiar pixels in a subsequent mapping process.

As a result, the processor proposed in the present invention operates at low power and high speed, enabling SLAM based on neural network rendering to be possible even on mobile devices. That is, the present invention may be applied to all fields requiring 3D information on mobile devices, and compared to 3D information generated by SLAM supported by existing mobile devices, information based on neural network rendering may be predicted even for unobserved areas, which significantly reduces a failure rate of conflict probability prediction, and may be utilized in applications such as autonomous robotics.

In addition, the present invention supports real-time training, and thus may be usefully utilized in virtual reality, augmented reality, etc., where the surrounding environment dynamically changes.

As described above, the processor and method for SLAM of the present invention may solve a problem of high latency of the neural network rendering algorithm by reducing the operation quantity by applying the real-time neural network (SMoE-NeRF) rendering technology utilizing the SMoE model acceleration architecture that requires a small operation quantity compared to the parameters, and as a result, may achieve acceleration in mobile devices. That is, the present invention has an effect of being able to reduce the operation quantity by a factor of 6.9 without accuracy loss compared to the existing SLAM algorithm by applying SMoE-NeRF.

In addition, the present invention solves a problem of frequent memory access required in the SMoE algorithm by rearranging an expert model access pattern that dynamically changes according to the input batch out of order, then converting the pattern into a matrix multiplication operation, and processing the operation, thereby having an effect of being able to achieve high throughput. That is, the present invention has an effect of achieving 6.5 times faster throughput by reducing the amount of data movement inside the chip by 88.8% compared to the existing hardware structure that processes the input batch in order by applying a scheduler (aka, OoO-SMoE router) that performs scheduling to process the input batch in order.

In addition, the present invention has an effect of additionally accelerating the SLAM algorithm while simultaneously achieving high energy efficiency by applying the HCG SC optimized for the data sparsity pattern. That is, the present invention may accelerate the matrix multiplication operation by utilizing sparsity in the HCG-SC core optimized for the data sparsity pattern occurring in three processes of neural network training, namely, inference FF, backpropagation BP, and weight update WG, thereby improving energy efficiency from 32.4% to 55.6% compared to the existing architecture and having an effect of additionally increasing throughput by 2.65 times.

In addition, the present invention has an effect of enabling low-power mapping by removing unnecessary 2D pixels in preprocessing of a neural network operation. That is, the present invention has an effect of being able to reduce energy consumption per frame by 42.9% compared to the conventional one while occupying only 2.8% of the area of the entire chip by identifying familiar pixels when a new image is input in the 2D sampling process, which is preprocessing of the neural network operation, and skipping mapping to the familiar pixels in a subsequent mapping process.

What is claimed is:

1. A processor for simultaneous localization and mapping (SLAM) based on real-time neural network rendering, the processor comprising:
a sampling unit configured to hierarchically sample a two-dimensional (2D) image collected through any image collection device and pose information of the image collection device corresponding to the 2D image; and
a rendering unit configured to perform SLAM through real-time rendering for data sampled by the sampling unit,
wherein the rendering unit comprises:
a computation core configured to perform a neural network operation based on a sparse expert model including a plurality of expert neural networks and reducing a number of neural network channels by exclusively activating an expert neural network differently selected for each input batch; and
a scheduler configured to schedule a processing order of input batches to improve computational efficiency of the computation core.

2. The processor according to claim 1, wherein:
the computation core comprises:
n expert neural network operators having N/n channels to perform an operation on a neural network having N channels; and
an expert decision neural network operator configured to dynamically select an expert neural network operator to be activated for each input batch among the n expert neural network operators, and
the expert decision neural network operator includes n output channels corresponding to the n expert neural network operators, respectively, performs an expert decision operation for each input batch which is input in order, and then selects a plurality of expert neural network operators for processing respective corresponding input batches according to a result thereof to activate a plurality of expert neural network operators corresponding to a plurality of output channels having largest expert decision operation results, respectively, for each input batch, where N and n are natural numbers greater than or equal to 1.

3. The processor according to claim 2, wherein the scheduler schedules a processing order of the input batches based on a selection result of the expert decision neural network operator, and performs scheduling so that input batches in which a plurality of expert neural network operators activated for each input batch does not overlap are selected out of order and processed in parallel.

4. The processor according to claim 3, wherein the scheduler receives selection information obtained by expressing, as 1-bit data, information on a plurality of expert neural network operators activated for each input batch from the expert decision neural network operator to generate a decision map DMAP, generates a score, which is weight information, between the plurality of expert neural network operators activated for each input batch, and then schedules a processing order of the input batches out of order based on the decision map DMAP and the score.

5. The processor according to claim 3, wherein:
the rendering unit further comprises an input/output memory in which M memory banks are arranged in order, where M is a natural number greater than or equal to 1, and
the scheduler is configured to:
generate M fist-in-first-out (FIFO) buffers arranged in order to correspond to the memory banks, respectively, then rearrange an access order of each of the input batches using the FIFO buffers, and
schedule out-of-order access of the memory banks so that a predetermined number of rearranged input batches is simultaneously stored in corresponding memory banks using a FIFO method.

6. The processor according to claim 2, wherein:
the computation core further comprises at least one integrated expert neural network operator for integrating and processing workload of each of a plurality of expert neural network operations, and
the scheduler couples a plurality of expert neural network operators so that total workload becomes similar based on workload of each of the expert neural network operators, and then performs scheduling so that integrated workload of the plurality of coupled expert neural network operators is processed by a single integrated expert neural network operator.

7. The processor according to claim 1, wherein the computation core comprises:
a single skip computation core configured to perform an operation for inference and backpropagation steps of the neural network operation and perform a matrix multiplication operation of a sparse matrix and a dense matrix; and
a double skip computation core configured to perform an operation for a weight update step of the neural network operation and perform a matrix multiplication operation of a sparse matrix and a sparse matrix.

8. The processor according to claim 1, wherein:
the sampling unit comprises:
a 2D sampling unit configured to sample the 2D image; and
a three-dimensional (3D) sampling unit configured to sample 3D data which is pose information of the image collection device, and
the 2D sampling unit and the 3D sampling unit are configured as a pipeline structure so that 2D image sampling and 3D data sampling are processed in parallel.

9. The processor according to claim 8, wherein the 2D sampling unit identifies a positional relationship between 2D image samples in different time periods, determines at least one familiar pixel predicted to have a low loss value among the 2D image samples in different time periods, and then performs scheduling to skip mapping to the familiar pixel.

10. A method for SLAM based on real-time neural network rendering using a SLAM processor configured to perform SLAM based on real-time neural network rendering, the method comprising:
a sampling step of hierarchically sampling, by the SLAM processor, a 2D image collected through any image collection device and pose information of the image collection device corresponding to the 2D image; and
a rendering step of performing, by the SLAM processor, SLAM through real-time rendering for data sampled in the sampling step,
wherein the rendering step comprises:
a scheduling step of scheduling a processing order of input batches to improve computational efficiency; and
a computation step of performing a real-time neural network operation based on a sparse expert model including a plurality of expert neural networks and reducing a number of neural network channels by exclusively activating an expert neural network differently selected for each input batch, and performing a neural network operation on the input batches based on information scheduled in the scheduling step.

11. The method according to claim 10, wherein:
the computation step comprises:
an expert decision step of dynamically selecting an expert neural network operator to be activated for each input batch among n expert neural network operators having N/n channels to perform an operation on a neural network having N channels; and
an expert computation step of performing an operation on a corresponding input batch using an expert neural network operator activated for each input batch in the expert decision step,
the expert decision step comprises:
an expert decision computation step of performing an expert decision operation for each input batch which is input in order using an expert decision operator including n output channels corresponding to the n expert neural network operators, respectively; and
an expert selection step of selecting a plurality of expert neural network operators for processing respective corresponding input batches according to an operation result of the expert decision operator, and
the expert selection step comprises activating a plurality of expert neural network operators corresponding to a plurality of output channels having largest expert decision operation results, respectively, for each input batch, where N and n are natural numbers greater than or equal to 1.

12. The method according to claim 11, wherein the scheduling step comprises scheduling a processing order of the input batches based on a selection result of the expert selection step, and performs scheduling so that input batches in which a plurality of expert neural network operators activated for each input batch does not overlap are selected out of order and processed in parallel.

13. The method according to claim 12, wherein the scheduling step comprises:
a decision map generation step of receiving selection information obtained by expressing, as 1-bit data, information on a plurality of expert neural network operators activated for each input batch from the expert decision neural network operator to generate a decision map DMAP; and
an out-of-order processing scheduling step of generating a score, which is weight information, between the plurality of expert neural network operators activated for each input batch, and then scheduling a processing order of the input batches out of order based on the decision map DMAP and the score.

14. The method according to claim 12, wherein the scheduling step comprises:
a rearranging step of generating M FIFO buffers arranged in order to correspond to M memory banks included in the SLAM process to store input/output batches, respectively, and then rearranging an access order of each of the input batches using the FIFO buffers, where M is a natural number greater than or equal to 1; and
an out-of-order memory access scheduling step of scheduling out-of-order access of the memory banks so that a predetermined number of rearranged input batches is simultaneously stored in corresponding memory banks using a FIFO method.

15. The method according to claim 11, wherein the scheduling step comprises:
a coupling step of coupling a plurality of expert neural network operators so that total workload becomes similar based on workload of each of the expert neural network operators; and
an integrated processing scheduling step of performing scheduling so that integrated workload of the plurality of coupled expert neural network operators is processed using at least one integrated operator implemented to integrate and process workload of each of any two expert neural network operators.

16. The method according to claim 10, wherein the computation step comprises:
a single skip computation step of performing a single skip operation for inference and backpropagation steps of the neural network operation by a matrix multiplication operation of a sparse matrix and a dense matrix; and
a double skip computation step of performing a double skip operation for a weight update step of the neural network operation by a matrix multiplication operation of a sparse matrix and a sparse matrix.

17. The method according to claim 10, wherein the sampling step comprises:
a 2D sampling step of sampling the 2D image; and
a 3D sampling step of sampling 3D data which is pose information of the image collection device, and
the 2D sampling step and the 3D sampling step are processed in parallel.

18. The method according to claim 17, wherein the 2D sampling step comprises a mapping skip scheduling step of identifying a positional relationship between 2D image samples in different time periods, determining at least one familiar pixel predicted to have a low loss value among the 2D image samples in different time periods, and then performing scheduling to skip mapping to the familiar pixel.
